(19) United States
(12) Patent Application Publication
(10) Pub. No.: US 2007/0173128 A1
(43) Pub. Date: Jul. 26, 2007

(54) Electrical connector defining a contact curvature

(75) Inventors: Timothy ChinSoon Yoap, Singapore (SG); HwaLiang Ng, Singapore (SG); George P. Thomas, Singapore (SG)

Correspondence Address: Fellers, Snider, Blankenship, Bailey & Tippens, Suite 1700, 100 North Broadway, Oklahama City, OK, 73102-0621, US

(73) Assignee: Seagate Technology LLC, Scotts Valley, CA (US)

(21) Appl. No.: 11/340,362

(22) Filed: Jan. 25, 2006

(51) Int. Cl. H01R 24/00

(52) U.S. Cl. 439/660

(57) ABSTRACT

An electrical connector apparatus comprising a housing supporting a plurality of contacts in a row, each of the contacts having an initial engagement surface, the plurality of initial engagement surfaces defining a contact curvature across the row that is configured for tangentially engaging a mating connector. A method providing an electrical device that is connectable to a receptacle by a connector having a plurality of contacts defining a contact curvature; inserting the electrical device into the receptacle to tangentially engage a portion of the connector on one of either the electrical device or the receptacle with the contact curvature on the other of the electrical device or receptacle, thereby initially contactingly engaging more than one but less than all of the plurality of contacts before contactingly engaging all the plurality of contacts.

### FIELD OF THE INVENTION

The embodiments of the present invention relate generally to the field of electronics devices and more particularly but without limitation to protecting electrical connector contacts from damage when connecting and disconnecting electronics devices.

### BACKGROUND

Modular electronics devices are the fundamental building blocks of system customization in suiting one's particular needs. Personal computer systems, for example, are typically outfitted with a receptacle into which the user can slidingly engage a peripheral device, such as a magnetic or optical storage device. The storage device typically has one of either a male or female connector and the receptacle has the other, such that the sliding engagement electrically connects the mating connectors.

Electronics devices have generally evolved to contain more complex circuitry packed into relatively smaller enclosures. For example, a 2.5″ form factor data storage device configured for the Advanced Technology Attachment (ATA) interface uses an electrical connector with 50 contacts. Packing that many contacts into such a small space means that by their size the contacts are susceptible to bending under normal insertion forces. Any such bending usually occurs during the initial contacting engagement of the male connector pins into misaligned female connector sockets.

Consequently, a significant amount of attention has been paid to ensuring adequate alignment of the connectors. Industry standards are provided for the variety of available interfaces, for example, that specify the size and location of the pins and sockets to ensure that different manufacturers′ components are swappable. However, standardization hasn't solved the problem of damaged pins and sockets from misalignment, so attempts have been made at minimizing the possible misalignment conditions. For example, in some attempted solutions alignment members are attached to the data storage device and the receptacle that engage each other before the pins and sockets are engaged. In other attempted solutions surface features on the pins and sockets facilitate a smoother entry of the pin into a misaligned socket.

These attempts and others like them are relatively expensive to implement, and are increasingly problematic in the face of size and space related constraints. They also do not address the problem of misaligned connectors making initial contacting engagement at only one of the pin and socket pairs, such that the entire engagement force is initially transmitted to only one pin. What is needed is a solution whereby the pins and sockets are deliberately arranged and configured to initially contactingly engage a selected plurality of them, thereby distributing the engagement force across the plurality of pins. It is to these improvements that the embodiments of the present invention are directed.

### SUMMARY OF THE INVENTION

Embodiments of the present invention are generally directed to connectors for electrical devices.

In some embodiments an electrical connector apparatus is provided comprising a housing supporting a plurality of contacts in a row, each of the contacts having an initial engagement surface, the plurality of initial engagement surfaces defining a contact curvature across the row that is configured for tangentially engaging a mating connector.

In some embodiments a method is provided comprising providing an electrical device that is connectable to a receptacle by a connector having a plurality of contacts defining a contact curvature; inserting the electrical device into the receptacle to tangentially engage a portion of the connector on one of either the electrical device or the receptacle with the contact curvature on the other of the electrical device or receptacle, thereby initially contactingly engaging more than one but less than all of the plurality of contacts before contactingly engaging all the plurality of contacts.

In some embodiments an electrical device in combination with a receptacle is provided for connecting the electrical device in electrical communication with another device. The combination has an electrical connector having one set of contacts attached to the electrical device and a respective set of contacts attached to the receptacle; and means for aligning the sets of contacts when matingly engaging the electrical device and the receptacle.

These and various other features and advantages which characterize the claimed invention will become apparent upon reading the following detailed description and upon reviewing the associated drawings.

### BRIEF DESCRIPTION OF THE DRAWINGS

FIG. 1 is an isometric view of a data storage device constructed in accordance with embodiments of the present invention.

FIG. 2 is a functional block diagram of the data storage of FIG. 1 connected to a host.

FIG. 3 is a partial exploded view of the printed circuit board and connector of the data storage device of FIG. 1.

FIG. 4 is a partial cross sectional view of the connector of FIG. 3.

FIG. 5 is a diagrammatic plan view of the connector of FIG. 3.

FIG. 6 is a diagrammatic plan view of a connector constructed in accordance with embodiments of the present invention to provide a tangential contacting engagement with a contact curvature.

FIG. 7 is a diagrammatic plan view of a connector constructed in accordance with previous related art solutions.

FIG. 8 is an enlarged detail view of a portion of the connector of FIG. 6.

FIG. 9 is an enlarged detail view of a portion of the connector of FIG. 7.

FIG. 10 is a diagrammatic plan view of the data storage device of FIG. 1 slidingly engaging a receptacle.

FIG. 11 is similar to FIG. 10 but showing the data storage device misaligned within the receptacle.

FIG. 12 is a diagrammatic view related to the derivation of the radius of contact curvature.

FIG. 13 is a diagrammatic plan view of a connector constructed in accordance with alternative embodiments of the present invention.

FIG. 14 is a diagrammatic plan view of a connector constructed in accordance with alternative embodiments of the present invention.

### DETAILED DESCRIPTION

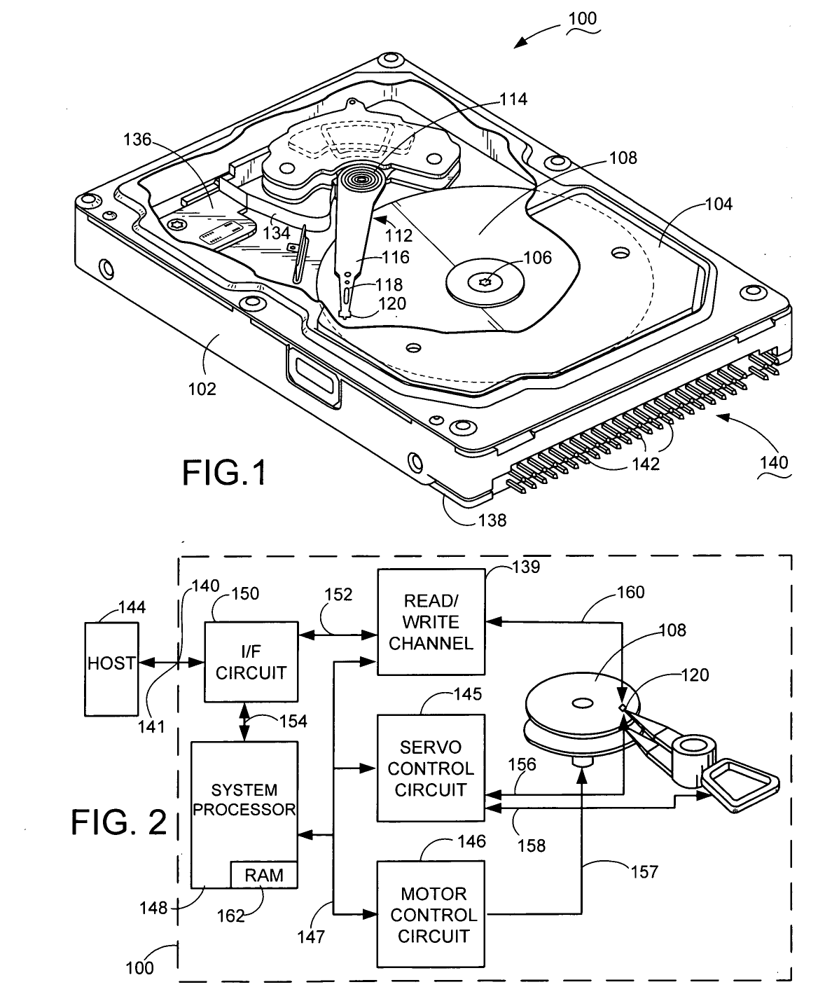

Referring to the drawings in general, and more particularly to FIG. 1 that shows an isometric view of a data storage device 100 constructed in accordance with embodiments of the present invention. The device 100 preferably includes a base 102 and a cover 104 (partially cutaway), which together provide a housing for a number of components. The components include a motor 106 to which one or more data storage mediums 108 are mounted for rotation therewith. Adjacent the medium 108 is an actuator assembly 112 that pivots around a bearing assembly 114. The actuator assembly 112 includes an actuator arm 116 supporting a load arm 118 that, in turn, supports a head 120 in a data transfer relationship with the adjacent medium 108. Each medium 108 can be divided into data tracks, and the head 120 is positioned to retrieve data from and store data to the tracks.

To provide the requisite electrical conduction paths between the head 120 and device 100 control circuitry, head wires can be routed on the actuator assembly 112 from the head 120, along the load arm assembly 118 and the actuator arm 116, and to a flex circuit 134. The head wires are thus connected to one end of the flex circuit 134 and the other end is connected to a flex circuit bracket 136. There the electrical connections pass through the base 102 to a printed circuit board (PCB) 138, which can be mounted externally to the enclosure.

An electrical connector 140 attached to the PCB 138 has a plurality of contacts for connecting the device 100 to a mating connector (not shown), such as for placing the device 100 in communication with external control circuitry. The embodiments of FIG. 1 illustrate the use of a male electrical connector 140, having pins 142 that are matingly alignable with and insertable into a like number and arrangement of sockets in a mating female connector (not shown). In alternative equivalent embodiments, however, the device 100 can have a female connector that is alignable with and receivingly engageable of a male connector.

FIG. 2 is a functional block diagram illustrating types of control signals and data transfers that are passed between the device 100, having the connector 140, and a host 144, having a mating connector 141. The device 100 generally has a read/write channel 143, a servo control circuit 145, and a motor control circuit 146, all connected by a control bus 147 to a controlling system processor 148. An interface circuit 150 is connected to the read/write channel 143 by bus 152 and to the system processor 148 by bus 154. The interface circuit 150 serves as a communications interface between the device 100 and the host device (or other network server) 144. Generally, in response to an access command from the host 144 and received by the system processor 148 from the interface 150, the processor 148 controls the flow of data to and from the medium 108. The read/write channel 143, in turn, provides store and retrieve signals to the head 120 in order to store data to the medium 108 and retrieve data from the medium 108. The head 120 can, for example, provide an analog read signal to the read/write channel 143, which in turn converts the analog read signal to digital form and performs the necessary decoding operations to provide data to the interface circuit 150 for output to the host 144.

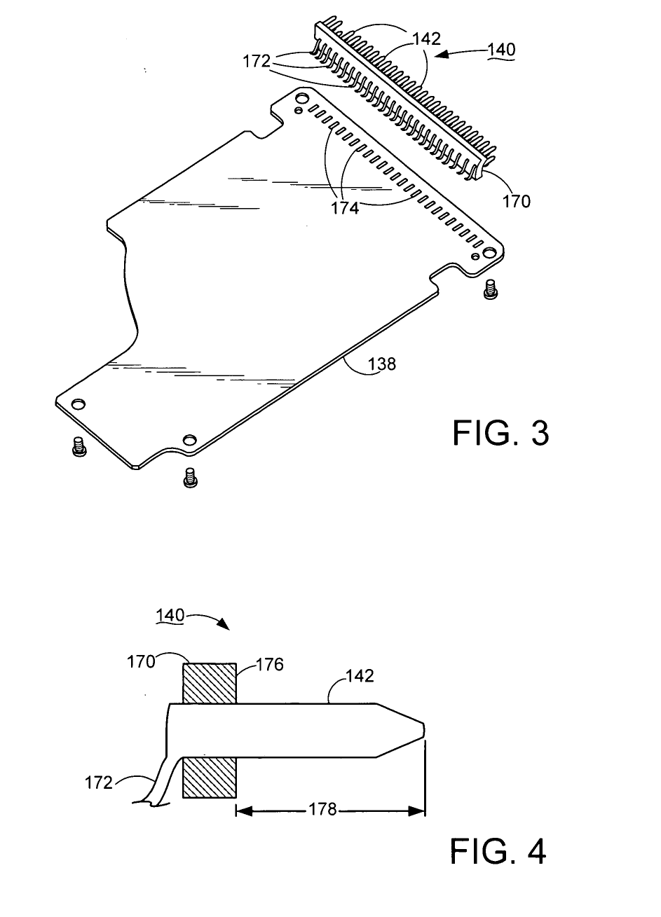

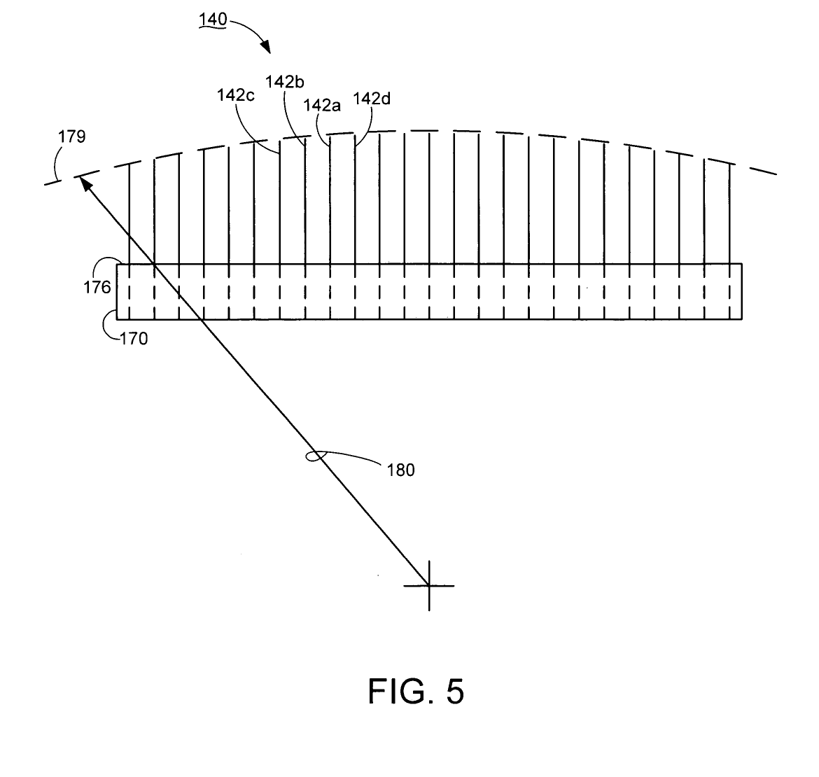

FIG. 3 is an exploded view of the PCB 138 and its connector 140. The connector 140 generally has a dielectric housing 170 supporting the plurality of pins 142 on one side thereof with leads 172 from each of the pins 142 connected to corresponding pads 174 of the PCB 138. FIG. 4 is a partial cross sectional view of one of the pins 142, showing the manner in which it extends laterally from a longitudinal surface 176 of the housing 170, thereby defining an effective length 178. For purposes of this description and the appended claims, the term “effective length” means the length of the pin 142 extending beyond the surface 176 of the housing 170. In some embodiments where the mating connector (not shown) abuttingly engages the surface 176 when fully engaged, then the effective length 178 is also the insertion length of the pins 142. The distal end of each pin 142 defines an initial engagement surface that first contactingly engages an opposing connector during connection therewith.

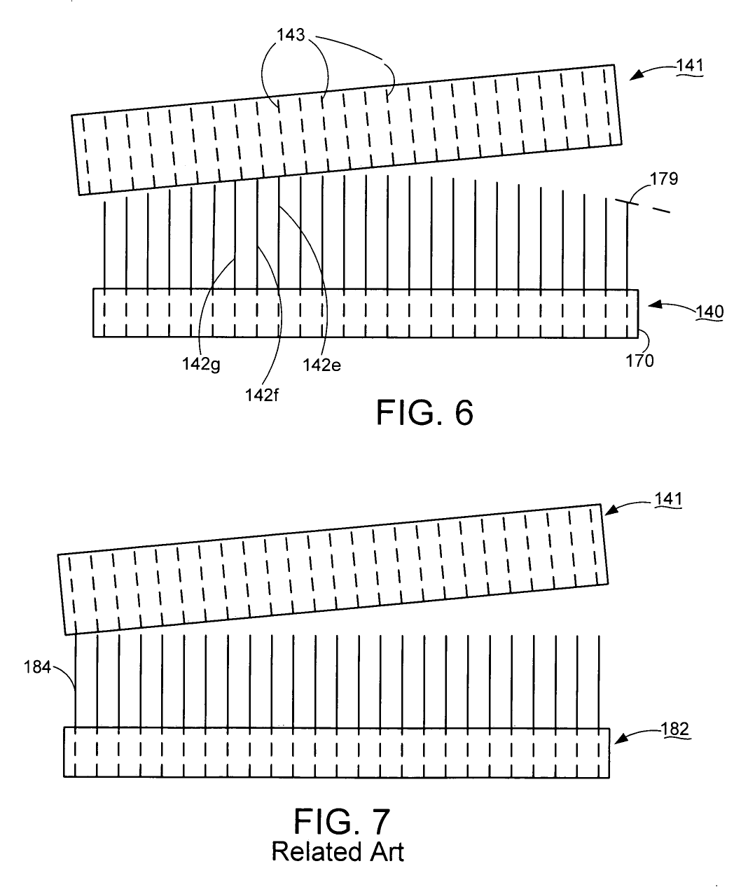

FIG. 5 is a diagrammatic plan view of the connector 140 more clearly illustrating the manner in which the pins 142 define different effective lengths 178 across a row of the contacts. That is, outwardly disposed pins 142a, 142b, 142c in the row have effective lengths 178 that are incrementally shorter in relation to the effective length 178 of a centrally disposed contact 142d. The distal ends of the pins 142 define an arcuate contact curvature 179, preferably with a common radius of curvature (R) 180. As shown in FIG. 6, this arrangement permits the connector 141 to tangentially engage the contact curvature 179 at the initial contacting engagement of the connectors 140, 141, regardless of any misalignment therebetween. By “tangentially engage” it is meant that a selected number of the pins 142, in this case three pins 142e, 142f, 142g contactingly engage a respective number of sockets 143 at the initial contacting engagement of the connectors 140, 141. The tangentially engaged pins 142e, 142f, 142g bear the engagement force until its continued application aligns the connectors 140, 141 so that the rest of the pins 142 and sockets 143 can engage. Tangentially engaging the contact curvature 179 thus distributes the engagement force across the preselected number of pins 142. Accordingly, each pin 142 bears relatively less force than where the entire engagement force is supported by only one pin, such as in the straight connector of FIG. 7 with regard to pin 184.

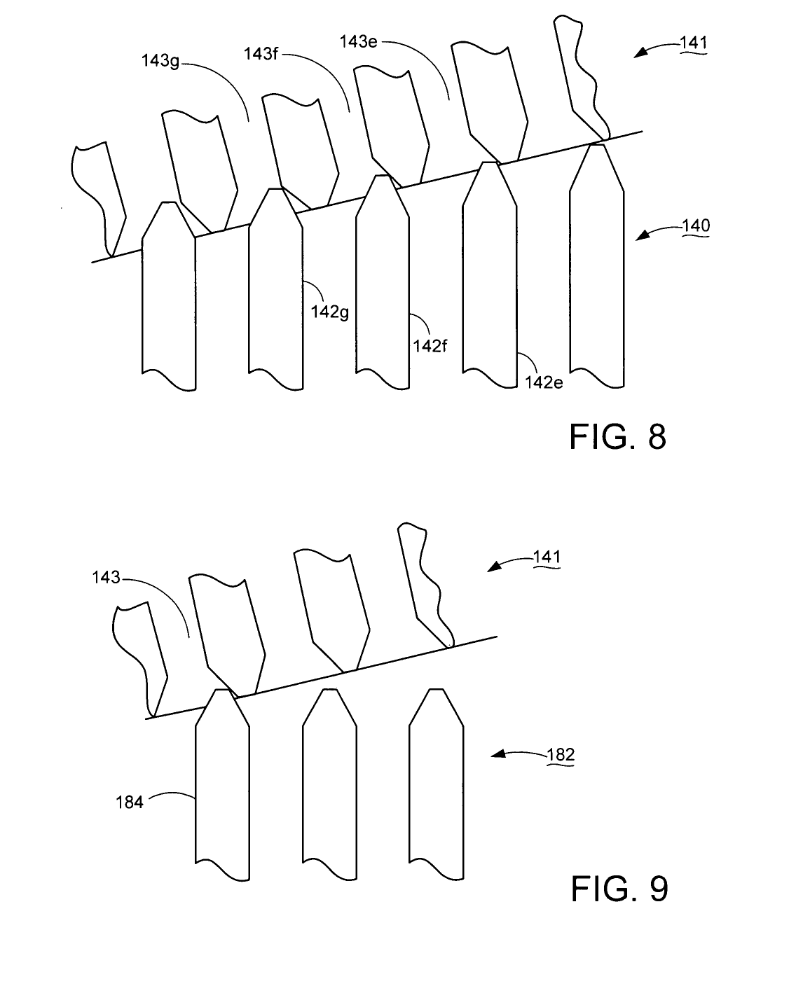

FIGS. 8 and 9 are enlarged detail views of FIGS. 6 and 7, respectively, more clearly showing that during the initial contacting engagement the pins 142e, 142f, 142g in FIG. 8 each bear about ⅓ the force that pin 184 of FIG. 9 bears. The pins 142 are thereby less likely to bend as they slidingly engage the chamfered surfaces of the sockets 143, thereby bringing the connectors 140, 141 into a fine alignment whereat the other pins 142 and sockets 143 are aligned.

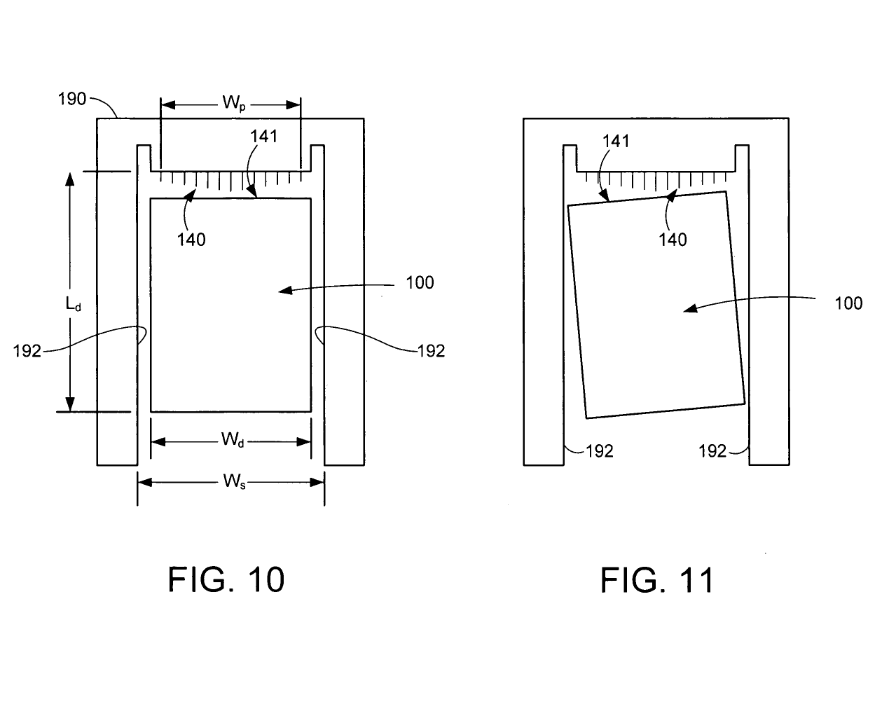

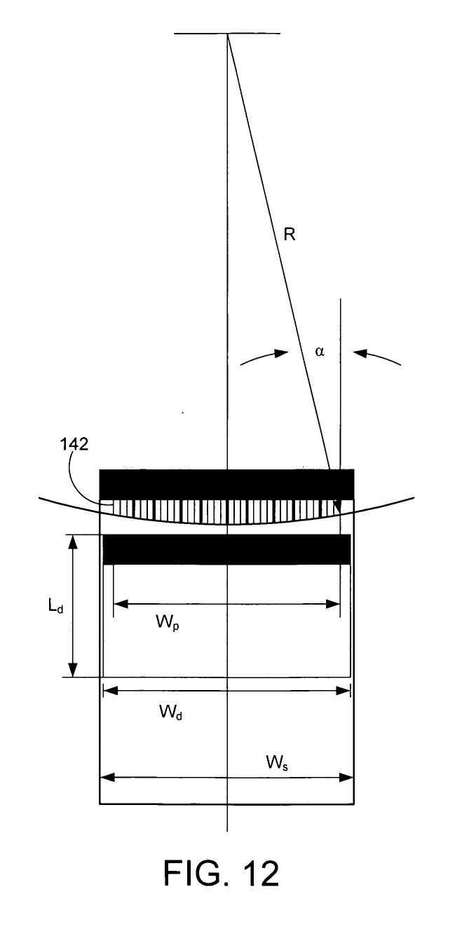

FIGS. 10-12 are diagrammatical plan views of the device 100 having the female connector 141 as a part thereof for connecting to a receptacle 190 having the male connector 140 as a part thereof. The receptacle 190 can be any of a number of devices used in conjunction with a data storage device, such as but not limited to a computer chassis, a multiple disc array carrier, a testing bay, and the like. Also, in equivalent alternative embodiments the female connector 141 can be part of the receptacle 190 and the male connector 140 part of the device 100, as illustrated in FIG. 1.

For facilitating the engagement of the connectors 140, 141 it can be advantageous to provide opposing guides 192 in the receptacle 190 for sliding the device 100 toward the connector 140. Clearances are necessary between the device 100 and the guides 192 in order to slide the device 100 into contacting engagement without undue force or damage. However, the extent of possible misalignment is directly proportional to the amount of clearance. The amount of clearance is related to the width of the device, W_{d}, which is less than the width of the space between the guides, Wₛ. Although the clearance is pictorially exaggerated in FIGS. 10 and 11 for clarity sake, FIG. 11 illustrates how the device 100 can become misaligned within the guides 192 during the sliding engagement.

The radius of the contact curvature (R) 180 for the pins 142 of the male connector can be calculated in relation to W_{d} and Wₛ, the length of the device, L_{d}, and the width of the row of pins 142, Wᵣ. In some embodiments a tilt angle, α, of the connector 141 can be calculated in terms of these dimensions as follows:

$$α = {tan}^{- 1} [ \frac{{L}_{d}}{{W}_{d}} ] - {cos}^{- 1} [ \frac{{W}_{s}}{\sqrt{{L}_{d}^{2} + {W}_{d}^{2}}} ]$$

R can then be calculated in terms of α and Wᵣ as follows:

$$R = \frac{{W}_{r}}{2 cos ( α ) sin ( α )}$$

Curve fitting can then be used to calculate the number of pins 142 that contactingly engage the sockets 143 at the tangential contacting engagement. For the tangentially engaged pins 142, the included angle of the socket 143 within the chamfered portion, β, and the insertion depth in the socket 143 within the chamfered portion, δ, are related in terms of:
δ=R(1−cos(β))

Solving this relationship for β provides:

$$β = {cos}^{- 1} [ 1 - \frac{δ}{R} ]$$

Given a pitch of the pins 142, ρ, the minimum number of pins 142 in tangential contacting engagement is calculated as:

$$NUM = R [ \frac{sin ( β )}{2 ρ} ]$$

The radius of curvature R can thus be adjusted to provide a preselected number of tangentially engaging pins 142, based on, for example, a desired maximum stress on each pin 142 resulting from the engagement force.

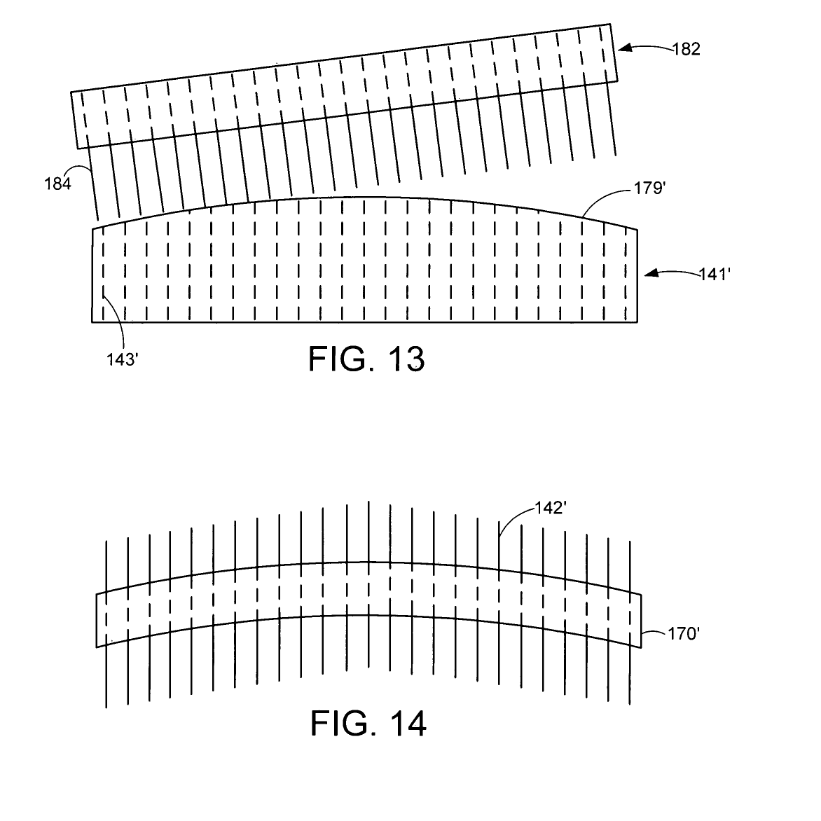

The contemplated embodiments are not limited to the description of the illustrative embodiments discussed hereinabove. For example, the embodiments of FIG. 6 and others illustrate the male connector 140 having different length pins 142 defining the contact curvature 179. The skilled artisan readily recognizes that in alternative equivalent embodiments of FIG. 13 the female connector 141′ has a curvilinear face defining the contact curvature 179′ for tangentially engaging the straight pins 184 of the male connector 182. For another example, the embodiments of FIG. 6 and others illustrate the male connector 140 having a linear housing 170 from which different-length pins 142 extend defining the contact curvature 179. The skilled artisan readily recognizes that in alternative equivalent embodiments the pins 142 can be of equal length with the insertion depth incrementally varied in order to define the contact curvature 179. Alternatively, FIG. 14 illustrates the housing 170′ being curvilinear with equal-length pins 142′ at a common insertion depth to define the contact curvature 179. Using a common length of pins 142 simplifies the production process by significantly reducing the number of unique parts making up a connector assembly.

In some embodiments one or more ground contacts are included within the plurality of contacts for hot-swappable applications. In some embodiments a ground contact can be a contact pin that extends longer than any of the other pins so that it electrically engages a mating connector before any other contact electrically engages, regardless of any misalignment between the connectors. In equivalent alternative embodiments a plurality of ground contact pins can extend longer than the other contact pins, with the ground pins themselves defining their own radius of contact curvature so that a preselected number of them initially contactingly engage in the same ways and for the same reasons discussed above. In other equivalent alternative embodiments the ground contacts can form part of the contact curvature and be interspersed throughout the row so that at least one of the ground contacts is always within the preselected number of tangentially engaged contacts, regardless of any misalignment between the connectors.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the devices in which they are incorporated or the particular environment in which they are used without departing from the spirit and scope of the present invention.

In addition, although the illustrative embodiments described herein are directed to a data storage system, it will be appreciated by those skilled in the art that the claimed subject matter is not so limited and various other electronic devices can utilize the embodiments of the present invention without departing from the spirit and scope of the claimed invention.

1. An electrical connector apparatus comprising a housing supporting a plurality of contacts in a row, each of the contacts having an initial engagement surface, the plurality of initial engagement surfaces defining a contact curvature across the row, the housing and contacts enabling the electrical connector to initially make a tangential contacting engagement between the contact curvature and a mating connector when connecting the electrical connector and the mating connector together.

2. The apparatus of claim 1 characterized as a male connector wherein the contacts extend laterally from a longitudinal surface of the housing defining different effective lengths, and wherein outwardly disposed contacts in the row define effective lengths that are incrementally shorter in relation to a centrally disposed contact in the row.

3. The apparatus of claim 2 wherein the contact curvature is defined by a common radius of curvature.

4. The apparatus of claim 2 wherein the longitudinal surface of the housing is linear and the contacts comprise different lengths.

5. The apparatus of claim 2 wherein the longitudinal surface of the housing is linear and the contacts comprise a common length.

6. The apparatus of claim 2 wherein the longitudinal surface of the housing is curvilinear.

7. The apparatus of claim 1 characterized as a female connector wherein the initial engagement surfaces are substantially flush with an arcuate longitudinal surface of the housing.

8. The apparatus of claim 1 connected to an electrical device that is slidable in a guide for engagement with a mating connector, wherein a radius of the contact curvature (R) is determined in relation to a length of the electrical device (L_{d}), a width of the electrical device (W_{d}), a width of a space defined by the guide (Wₛ), and a width of the row of contacts (Wᵣ).

9. The apparatus of claim 8 wherein the radius of curvature is defined by:
$$R = \frac{{W}_{r}}{2 cos ( α ) sin ( α )}$$
$$where$$
$$α = {tan}^{- 1} [ \frac{{L}_{d}}{{W}_{d}} ] - {cos}^{- 1} [ \frac{{W}_{r}}{\sqrt{{L}_{d}^{2} + {W}_{d}^{2}}} ]$$

10. A method comprising:
providing an electrical device that is connectable to a receptacle by a connector having a plurality of contacts defining a contact curvature;
inserting the electrical device into the receptacle to tangentially engage a portion of the connector on one of either the electrical device or the receptacle with the contact curvature on the other of the electrical device or receptacle, thereby initially contactingly engaging more than one but less than all of the plurality of contacts before contactingly engaging all the plurality of contacts.

11. The method of claim 10 wherein the providing step is characterized by defining the contact curvature in a male connector.

12. The method of claim 10 wherein the providing step is characterized by defining the contact curvature in a female connector.

13. The method of claim 10 wherein the providing step is characterized by defining the contact curvature with a common radius.

14. The method of claim 10 wherein the providing step is characterized by orienting a portion of the connector defining the contact curvature in convex relation to a mating portion of the connector.

15. The method of claim 11 wherein the providing step is characterized by defining the contact curvature by a plurality of contact pins having the same length.

16. An electrical device in combination with a receptacle for connecting the electrical device in electrical communication with another device, comprising:
an electrical connector having one set of contacts attached to the electrical device and a respective set of contacts attached to the receptacle defining paired contacts; and
means for aligning the sets of contacts when matingly engaging the electrical device and the receptacle.

17. The combination of claim 16 wherein the means for aligning is characterized by the sets of contacts approaching each other substantially within a common plane but being nonparallel with respect to each other.

18. The combination of claim 16 wherein the means for aligning is characterized by contactingly engaging more than one paired contacts of the sets of contacts but less than all the paired contacts of the sets of contacts for aligning noncontactingly disengaged sets of contacts.

19. The combination of claim 18 wherein the means for aligning is characterized by one of the sets of contacts defining a radius of contact curvature that is related to a length and width of the electrical device, to a width of the receptacle, and to a width of a row of the set of contacts.

20. The combination of claim 19 wherein the means for aligning is characterized by preselecting a desired plurality of the paired contacts to make contacting engagement for aligning noncontactingly disengaged paired contacts in order to distribute an initial engagement force applied to the connector across the desired plurality of paired contacts.
